(19) United States
(12) Patent Application Publication
(10) Pub. No.: US 2010/0168279 A1
(43) Pub. Date: Jul. 1, 2010

(54) THERMALLY CURABLE EPOXY-AMINE BARRIER SEALANTS

(76) Inventors: Shengqian Kong, Edison, NJ (US); Sarah E. Grieshaber, Manville, NJ (US); Donald E. Herr, Doylestown, PA (US)

Correspondence Address: Henkel Corporation, 10 Finderne Avenue, Bridgewater, NJ, 08807, US

(21) Appl. No.: 12/293,741

(22) PCT Filed: Mar. 30, 2006
(86) PCT No.: PCT/US06/12657

§ 371 Date: Sep. 19, 2008

(51) Int. Cl. C08L 63/00; C08K 3/36; C08K 3/04; C08K 3/22; C08K 3/38; C08K 3/32

(52) U.S. Cl. 523/445; 523/400; 523/466; 523/468; 523/457; 523/451

(57) ABSTRACT

This invention is a barrier composition comprising a resin or resin/filler system that is capable of being cured at low temperature while still maintaining superior barrier performance. This composition comprises (a) an aromatic compound having meta-substituted epoxy functionalities; (b) a multifunctional aliphatic amine; (c) optionally, one or more fillers; (d) optionally one or more adhesion promoters; (c) optionally, a phenolic cure accelerator.

This Invention was made with support from the Government of the United States of America under Agreement No. MDA972-93-2-0014 awarded by the Army Research Laboratories. The Government has certain rights in the Invention.

### FIELD OF THE INVENTION

This invention relates to barrier sealants, adhesives, encapsulants, and coatings for use in electronic and optoelectronic devices. (As used in this specification and claims, adhesives, sealants, encapsulants, and coatings are similar materials, all having adhesive, sealant, and coating properties and functions. When any one is recited, the others, are deemed to be included.)

### BACKGROUND

Polymeric barrier materials are widely used in many packaging and protective applications such as food, beverages, medical products, cosmetics, agricultural products, electronic components, molding, piping, and tubing. As barriers, they limit the exchange of permeant molecules between the environment and the system being protected and therefore, preserve the flavor or aroma of food or cosmetic ingredients, prevent moisture or oxygen from degrading the electronic components, and protect automotive fascia component surfaces from penetration by solvents commonly used in paints or primer. Since different systems require different barrier properties, a good barrier in one application might be considered a poor one in another.

Numerous optoelectronic devices are moisture or oxygen sensitive and need to be protected from exposure during their functional lifetime. A common approach is to seal the device between an impermeable substrate on which it is positioned and an impermeable glass or metal lid, and seal or adhere the perimeter of the lid to the bottom substrate using a curable adhesive or sealant.

A common manifestation of this package geometry is exemplified in FIG. 1, which discloses the use of a curable perimeter sealant (1) to bond a metal or glass lid (2) over an organic light emitting diode (OLED) stack (3) fabricated on a glass substrate (4). Although various configurations exist, a typical device also contains an anode (5), a cathode (6), and some form of electrical interconnect between the OLED pixel/device and external circuitry (7). For the purposes of this invention, no particular device geometry is specified or required aside from one which incorporates an adhesive/sealant material such as a perimeter sealant (1).

In many configurations, such as that shown in FIG. 1, both the glass substrate and the metal/glass lid are essentially impermeable to oxygen and moisture, and the sealant is the only material with any appreciable permeability that surrounds the device. For electronic and optoelectronic devices, moisture permeability is very often more critical than oxygen permeability; consequently, the oxygen barrier requirements are much less stringent, and it is the moisture barrier properties of the perimeter sealant that are critical to successful performance of the device.

Good barrier sealants will exhibit low bulk moisture permeability, good adhesion, and strong interfacial adhesive/substrate interactions. If the quality of the substrate to sealant interface is poor, the interface may function as a weak boundary, which allows rapid moisture ingress into the device regardless of the bulk moisture permeability of the sealant. If the interface is at least as continuous as the bulk sealant, then the permeation of moisture typically will be dominated by the bulk moisture permeability of the sealant itself.

It is important to note that one must examine moisture permeability (P) as the measure of effective barrier properties and not merely water vapor transmission rate (WVTR), as the latter is not normalized to a defined path thickness or path length for permeation. Generally, permeability can be defined as WVTR multiplied by permeation path length, and is, thus, the preferred way to evaluate whether a sealant is inherently a good barrier material.

The most common ways to express permeability are the permeability coefficient (e.g. g·mil/100 in²·da·atm), which applies to any set of experimental conditions, or the permeation coefficient (e.g. g·mil/100 in²·day at a given temperature and relative humidity), which must be quoted with the experimental conditions in order to define the partial pressure/concentration of permeant present in the barrier material. In general, the penetration of a permeant through some barrier material (permeability, P) can be described as the product of a diffusion term (D) and a solubility term (S): P=D·S

The solubility term reflects the affinity of the barrier for the permeant, and, in relation to water vapor, a low S term is obtained from hydrophobic materials. The diffusion term is a measure of the mobility of a permeant in the barrier matrix and is directly related to material properties of the barrier, such as free volume and molecular mobility. Often, a low D term is obtained from highly crosslinked or crystalline materials (in contrast to less crosslinked or amorphous analogs). Permeability will increase drastically as molecular motion increases (for example as temperature is increased, and particularly when the T_{g} of a polymer is exceeded).

Logical chemical approaches to producing improved barriers must consider these two fundamental factors (D and S) affecting the permeability of water vapor and oxygen. Superimposed on such chemical factors are physical variables: long permeation pathways and flawless adhesive bondlines (good wetting of the adhesive onto the substrate), which improve barrier performance and should be applied whenever possible. The ideal barrier sealant will exhibit low D and S terms while providing excellent adhesion to all device substrates.

It is not sufficient to have only a low solubility (S) term or only a low diffusivity (D) term in order to obtain high performance barrier materials. A classic example can be found in common siloxane elastomers. Such materials are extremely hydrophobic (low solubility term, S), yet they are quite poor barriers due to their high molecular mobility due to unhindered rotation about the Si—O bonds, which produces a high diffusivity term (D). Thus, many systems that are merely hydrophobic are not good barrier materials despite the fact that they exhibit low moisture solubility. Low moisture solubility must be combined with low molecular mobility and, thus, low permeant mobility or diffusivity.

Epoxy-amine chemistry based barriers have been used in food packaging for many years. These crosslinked coatings were found to have excellent oxygen barrier properties. However, it is generally known that oxygen and moisture permeability do not necessary follow the same trend. In addition, in order to gain the full potential of these coatings, materials are generally cured at high temperatures for prolonged time (typically 100° C. for 60 minutes). These harsh conditions could be detrimental to electroluminescent materials or plastic substrates used in many current and future display applications such as organic light-emitting devices (OLED), polymer light-emitting devices, charge-coupled device (CCD) sensors, liquid crystal displays (LCD), electrophoretic displays, and micro-electro-mechanical sensors (MEMS).

Due to demanding performance requirements for some applications, there is a need to further improve current barrier materials. In particular, there is a need for barrier materials that cure under 100° C., while maintaining good barrier performance, whether for food packaging or electronic and optoelectronic device packaging, or for any other type of applications that require barrier performance.

### BRIEF DESCRIPTION OF THE DRAWINGS

FIG. 1 is a perimeter sealed optoelectronic device.

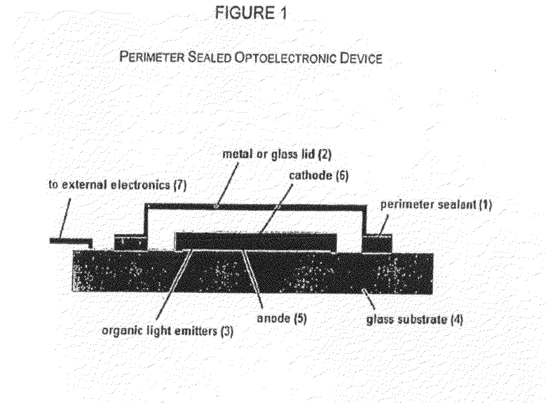

FIG. 2 is a Differential Scanning Calorimetry overlay of an epoxy/TEPA (amine) blend cured isothermally at 75° C. with and without a catalyst.

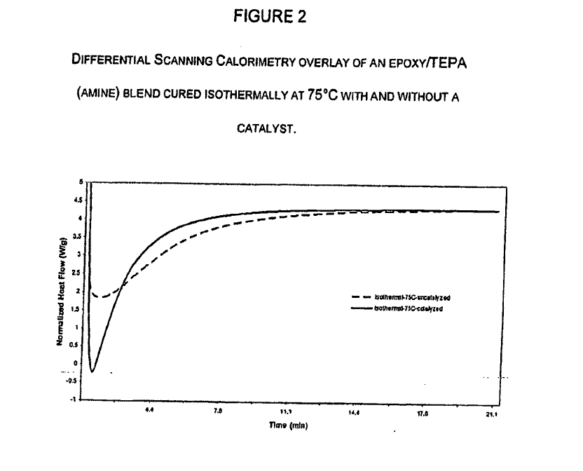

### SUMMARY OF THE INVENTION

This invention is a barrier composition comprising a resin or resin/filler system that is capable of being cured at low temperature while still maintaining superior barrier performance. This composition comprises (a) an aromatic compound having meta-substituted epoxy functionalities, (b) a multifunctional aliphatic amine, (c) optionally one or more fillers, (d) optionally, one or more adhesion promoters, and (e) optionally, a phenolic cure accelerator.

Such a barrier composition may be used alone or in combination with other curable resins and various fillers. The resulting compositions exhibit commercially acceptable cure rates, high crosslink densities, and good adhesion, which makes them effective for use in sealing and encapsulating a variety of articles of manufacture, and in particular electronic, optoelectronic, and MEMS devices.

In another embodiment, this invention is a low-temperature curable barrier composition comprising an aromatic epoxy compound selected from the group consisting of epoxided resoles, bisphenol-F diglycidyl ether, bisphenol-A diglycidyl ether, bisphenol-E diglycidyl ether, epoxidized phenol novolac resins, epoxidized cresol novolac resins, polycyclic epoxy resins, naphthalene diglycidyl ether, and halogenated derivatives of those; a multifunctional amine, and optionally, a phenolic curing accelerator.

### DETAILED DESCRIPTION OF THE INVENTION

This invention is a thermally curable barrier sealant comprising (a) an aromatic compound having meta-substituted epoxy functionalities and (b) a multi-functional aliphatic amine. The barrier adhesive or sealant optionally contains (c) one or more fillers, (d) one or more adhesion promoters.

For curing at lower temperature while maintaining good permeability performance, the thermally curable barrier sealant may further comprise (e) a phenolic curing accelerator.

In another embodiment, this invention is a low-temperature curable barrier composition comprising an aromatic epoxy compound selected from the group consisting of epoxidized resoles, bisphenol-F diglycidyl ether, bisphenol-A diglycidyl ether, bisphenol-E diglycidyl ether, epoxidized phenol novolac resins, epoxidized cresol novolac resins, polycyclic epoxy resins, naphthalene diglycidyl ether, and halogenated derivatives of those; a multifunctional amine; and optionally, a phenolic cure accelerator.

As used in this specification and claims, the words epoxy, epoxide, and oxirane (and their plurals) refer to the same compound or types of compounds.

The aromatic compound having meta-substituted epoxy functionalities will have the structure:

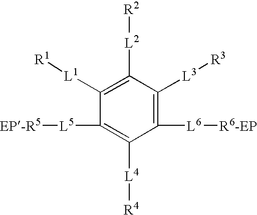

in which

R¹, R², R³, R⁴ are selected from the group consisting hydrogen, halogen, cyano, alkyl, aryl, and substituted alkyl or aryl groups, which may contain an epoxy functionality; R⁵ and R⁶ are divalent hydrocarbon linkers having the general structure —CₙH₂ₙ—, wherein n=0-4 (when n is 0, R⁵ and R⁶ are not present); in which any two of R¹, R², R³, R⁴, R⁵, and R⁶ may form part of the same cyclic structure;

L¹, L², L³, L⁴, L⁵, L⁶ are a direct bond or a divalent linking group selected

from the group consisting of

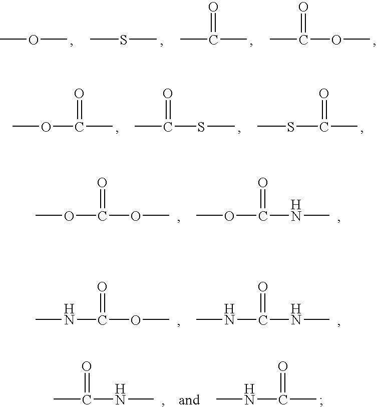

EP and EP′ are curable epoxy functionalities selected from the group consisting of aliphatic epoxy, glycidyl ether, cycloaliphatic epoxy.

Examples of the epoxy groups include, but are not limited to,

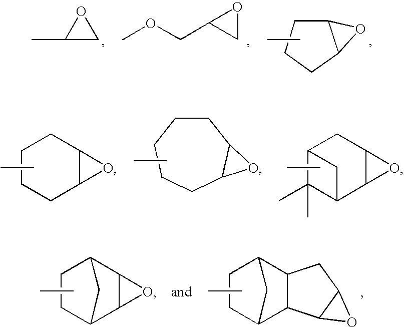

in which the hydrogens on the structures may be substituted by one or more alkyl or halogen groups.

Exemplary aromatic compounds having meta-substituted epoxy functionalities include, but are not limited to:

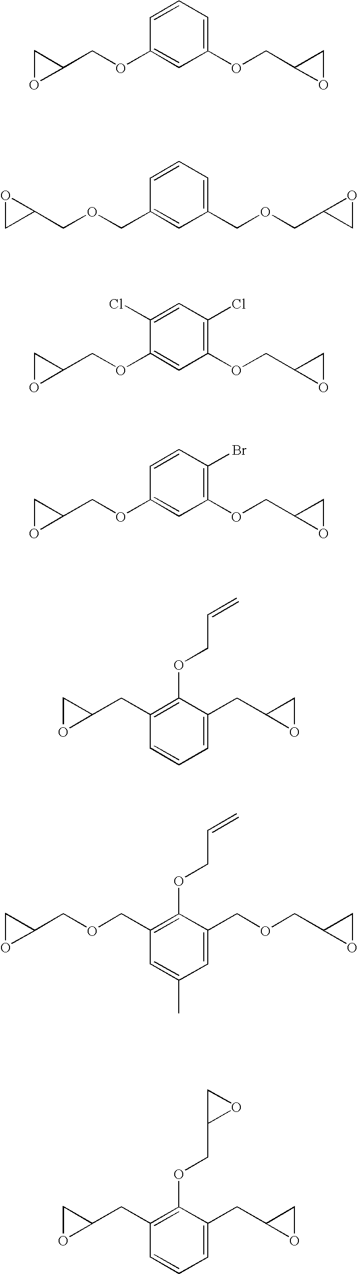

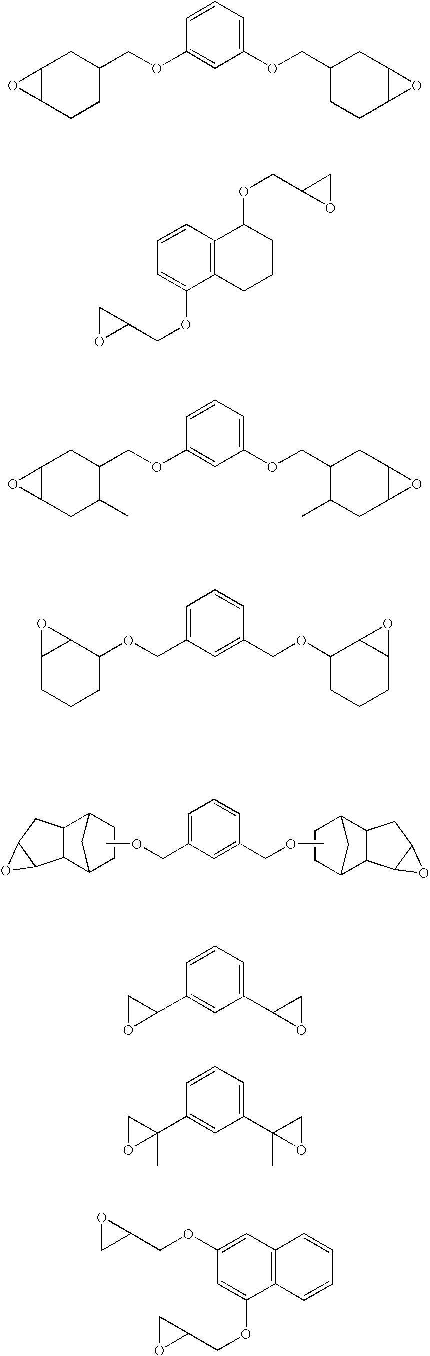

To satisfy various performance requirements, one or more additional epoxy resins may be used, and these resins are preferably selected from the group consisting of bisphenol F diglycidyl ether, novolac glycidyl ethers, polycyclic epoxies, naphthalene diglycidyl ether, and halogenated glycidyl ethers.

Within this specification, the term multifunctional aliphatic amine means amines that have at least two of the following groups present in the same molecule:

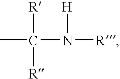

in which R′ and R″ are independently selected from the group consisting hydrogen, alkyl or substituted alkyl groups. R′″ is either a hydrogen or a divalent alkyl/substituted alkyl linking group. Suitable multifunctional aliphatic amines include, but are not limited to, those selected from the group consisting of

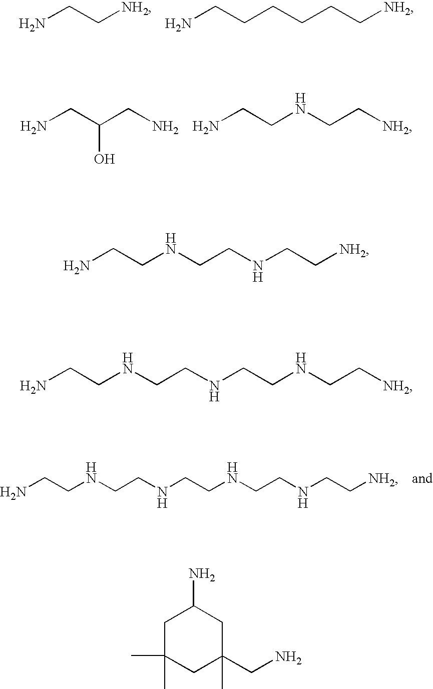

As used in this specification and claims, the words cure accelerator and catalyst refer to the same concept. Suitable accelerators are di- or multi-functional phenolic compounds. Suitable phenolic compounds include, but are not limited to, tris-2,4,6-(dimethyl aminomethyl)phenol, resorcinol, 4-ethylresorcinol, 2,5-dimethylresorcinol, phloroglucinol, 2-nitrophloro-glucinol, 5-methoxyresorcinol, orcinol, 2-methylresorcinol, 4-bromoresorcinol, 4-chlororesorcinol, 4,6-dichlororesorcinol, 3,5-dihydroxy-benzaldehyde, 2,4-dihydroxy-benzaldehyde, methyl 3,5-dihydroxy benzoate, methyl 2,4-dihydroxybenzoate, 1,2,4-benzenetriol, pyrogallol, 3,5-dihydroxybenzyl alcohol, 2′,6′-dihydroxyacetophenone, 2′,4′-dihydroxyacetophenone, 3′,5′-dihydroxyacetophenone, 2′,4′-dihydroxy-propiophenone, 2′,4′-dihydroxy-3′-methylacetophenone, 2,4,5-trihydroxy-benzaldehyde, 2,3,4-trihydroxybenzaldehyde, 2,4,6-trihydroxybenzaldehyde, 3,5-dihydroxybenzoic acid, 2,4-dihydroxybenzoic acid, 2,6-dihydroxybenzoic acid, 2-nitroresorcinol, 1,3-dihydroxynaphthalene, hydroquinone, methylhydroquinone, 2,3-dimethylhydroquinone, 2-methoxyhydroquinone, chlorohydroquinone, 2′,5′-dihydroxyacetophenone, 2-isopropyl-1,4-benzenediol, 2,5-dihydroxybenzoic acid, 2,3-dicyanohydroquinone, 1,4-dihydroxynaphthalene, 2′,5′-dihydroxypropiophenone, 1-(2,5-dihydroxy-4-methylphenyl)ethanone, tert-butylhydroquinone, methyl 2,5-dihydroxybenzoate, (2,5-dihydroxyphenyl)acetic acid, 2,4,5-trihydroxybenzoic acid, 4,7-dihydroxy-3-methyl-1-indanone, 2,5-dichlorohydroquinone, tetrafluoro-hydroquinone, ethyl 2,5-dihydroxybenzoate, 2-(2,5-dihydroxybenzylidene) malononitrile, 2-bromo-1,4-benzenediol, ethyl (2,5-dihydroxyphenyl)acetate, 1-(2,4,5-trihydroxyphenyl)-1-butanone, methyl 2,5-dihydroxy-4-methoxybenzoate, 2,6-dinitro-1,4-benzenediol, 2,4,5-trihydroxyphenylalanine, (2,5-dihydroxyphenyl)-(phenyl)methanone, 2,5-ditert-butyl-1,4-benzenediol, 2-(6-methylheptyl)-1,4-benzenediol, 2-(1,1,3,3-tetramethylbutyl)-1,4-benzenediol, dimethyl 2,5-dihydroxyterephthalate, 2,4,5-trichloro-3,6-dihydroxybenzonitrile, 2,5-ditert-pentyl-1,4-benzenediol, 2,5-dibromo-1,4-benzenediol, dimethyl 2,4-diethyl-3,6-dihydroxy-phenylphosphonate, pyrocatechol, 2,3-naphthalenediol, 5-methyl-1,2,3-benzenetriol, 4-methylcatechol, 3-methylcatechol, 3-fluorocatechol, 3-methoxycatechol, 4-chlorocatechol, 4,5-dichlorocatechol, 4-tert-butylcatechol, 3,4,5,6-tetrachloro-1,2-benzenediol, 3-isopropyl-6-methylcatechol, 3-tert-butyl-6-methylcatechol, 3,4-dihydroxybenzonitrile, 3,5-ditert-butylcatechol, 3,5-diisopropylcatechol, 3,4-dihydroxybenzaldehyde, 4-(1,1,3,3-tetramethylbutyl)-1,2-benzenediol, 4-(1,2-dihydroxyethyl)-1,2-benzenediol, 1-(3,4-dihydroxyphenyl)ethanone, 3,4-dihydroxybenzoic acid, 3,4,5-trihydroxybenzamide, 4-nitro-1,2-benzenediol, 4-(2-amino-1-hydroxyethyl)-1,2-benzenediol, 5-methyl-3-(1,1,3,3-tetramethylbutyl)-1,2-benzenediol, (3,4-dihydroxyphenyl)acetic acid, 2-(3,4-dihydroxybenzyl-idene)malononitrile, 3,5-dinitro-1,2-benzenediol, methyl 3,4-dihydroxybenzoate, 2-chloro-1-(3,4-dihydroxyphenyl)ethanone, phenyl(2,3,4-trihydroxyphenyl)methanone, isopropyl 3,4,5-trihydroxybenzoate, 3,4-dihydroxy-2-methylphenylalanine, 3-bromo-4,5-dihydroxybenzoic acid, 2-(3,4-dihydroxy-5-methoxybenzylidene)malononitrile, ethyl 3-(3,4-dihydroxyphenyl)propanoate, 2-phenyl-1-(2,3,4-trihydroxy-phenyl)ethanone, and 3,4,5-trihydroxy-N-(2-hydroxyethyl)benzamide.

Suitable fillers include, but are not limited to, ground quartz, fused silica, amorphous silica, talc, glass beads, graphite, carbon black, alumina, clays and nanoclays, mica, vermiculite, aluminum nitride, and boron nitride. Additional suitable fillers include metal powders and flakes, for example, silver, copper, gold, tin, tin/lead alloys, and other alloys. Organic filler powders such as poly(tetrachloroethylene), poly(chlorotrifluoroethylene), and poly(vinylidene chloride) may also be used. Fillers that act as desiccants or oxygen scavengers, including but not limited to, CaO, BaO, Na₂SO₄, CaSO₄, MgSO₄, zeolites, silica gel, P₂O₅, CaCl₂, and Al₂O₃ may also be utilized.

The ingredients of the epoxy-amine system may be premixed, or preserved in separate containers and mixed in-situ using equipment such as a static mixer. One may also partially premix the ingredients, for example, by adding a small fraction of the epoxy ingredient to the amine to make an amine oligomer/prepolymer. The amount of epoxy should be small enough so that no gellation occurs. This mixture is then further blended with the rest of the epoxy component. Alternatively, one may dissolve one or more of the components in a solvent or solvents before application.

Application of these formulations can be accomplished through a variety of processes including, but not limited to, syringe dispensing, screen printing, stencil printing, spraying, roll coating, inkjet printing, spin coating, dip coating, vacuum evaporation, and like processes. The choice of application method will depend on the article of manufacture and such choice is within the expertise of one skilled in the art.

### EXAMPLES

### Example 1

### Epoxy-Amine Blends at Various Ratios

This example demonstrates the importance of the epoxy-amine stoichiometry in a thermally curable blend. Mixtures of bisphenol-F diglycidyl ether (available as Epoxy Research Resin RSL-1739 from Hexion Specialty Chemicals) with triethylene tetramine (TETA, Aldrich) or tetraethylene pentamine (TEPA, ACROS) were combined in various ratios as shown in Table 1 (TETA samples) and Table 2 (TEPA samples). All of the samples listed in the tables contained 0.2 wt % of silicone surface additive BYK-310. Each sample was degassed in a vacuum chamber after mixing and cured at 100° C. for 100 minutes on a glass plate. Permeation coefficients of the cured samples were measured on Mocon Permeatran 3/33 at 50° C., 100% RH. As shown in these tables, the molar ratios of epoxy to amine molecules as well as the ratios of epoxy groups to amine nitrogens and epoxy groups to amine hydrogens were calculated. For TETA (Table 1), the lowest moisture permeation coefficients of 3.4 to 3.7 g·mil/100 in²·day were attained with a roughly 1 to 1 ratio of epoxy groups to amine hydrogens. This was determined to be the optimum ratio. With higher amounts of epoxy, the films became more brittle and more difficult to remove from the glass without breaking. With higher amounts of amine, the films became softer and did not cure well. The samples containing TEPA and RSL-1739 (Table 2) followed similar trends. The lowest moisture permeation coefficients were 3.6 to 4.0 g·mil/100 in²·day, and were again obtained with a 1 to 1 ratio of epoxy groups to amine hydrogens.

TABLE 1
RSL-1739/TETA formulations

| | | RSL-1739:TETA | | O (epoxy):N | O (epoxy):N—H | Permeation | |
|---|---|---|---|---|---|---|---|
| RSL- | TETA | Ratio | | (amine) | (amine) | (g · mil/100 in² · day) | Film |
| 1739 (g) | (g) | (wt.) | (molar) | Ratio | Ratio | (50° C., 100% RH) | Properties |
| 9.50 | 0.50 | 19.00 | 8.89 | 4.45 | 2.96 | — | very brittle |
| 9.00 | 1.00 | 9.00 | 4.21 | 2.11 | 1.40 | 4.6 | Brittle |
| 8.65 | 1.35 | 6.41 | 3.00 | 1.50 | 1.00 | 3.7 | Flexible |
| 8.61 | 1.39 | 6.19 | 2.90 | 1.45 | 0.97 | 3.4 | Flexible |
| 8.11 | 1.89 | 4.29 | 2.01 | 1.00 | 0.67 | 4.4 | flexible |
| 6.82 | 3.18 | 2.14 | 1.00 | 0.50 | 0.33 | — | not cured |
| 6.00 | 4.00 | 1.50 | 0.70 | 0.35 | 0.23 | — | very soft |
| 2.00 | 8.00 | 0.25 | 0.12 | 0.058 | 0.039 | — | not cured |

TABLE 2
RSL-1739/TEPA formulations

| | | RSL-1739:TEPA | | O (epoxy):N | O (epoxy):N—H | Permeation | |
|---|---|---|---|---|---|---|---|
| RSL- | TEPA | Ratio | | (amine) | (amine) | (g · mil/100 in² · day) | Film |
| 1739 (g) | (g) | (wt.) | (molar) | Ratio | ratio | (50° C., 100% RH) | Properties |
| 9.50 | 0.50 | 19.00 | 11.51 | 4.60 | 3.29 | — | not cured |
| 9.00 | 1.00 | 9.00 | 5.45 | 2.18 | 1.56 | 5.8 | brittle |
| 8.65 | 1.35 | 6.41 | 3.88 | 1.55 | 1.11 | 3.6 | slightly |
| | | | | | | | brittle |
| 8.53 | 1.47 | 5.80 | 3.52 | 1.41 | 1.00 | 4.0 | slightly |
| | | | | | | | brittle |
| 7.98 | 2.02 | 3.95 | 2.39 | 0.96 | 0.68 | 4.1 | flexible |
| 6.82 | 3.18 | 2.14 | 1.30 | 0.52 | 0.37 | 274.1 | very soft |

### Example 2

### Formulation with Various Epoxies

This example demonstrates the effect of epoxy structure on the permeability performance. Formulations of TEPA were prepared with other epoxies or combinations of epoxies including ERL-4221 (Dow Chemical), resorcinol diglycidyl ether (available from CVC Specialty Chemicals as ERISYS RDGE), and EpicIon EXA-835LV (Danippon Ink and Chemicals Co.). The formulations with their permeation results are shown in Table 3. All formulations were prepared with a 1 to 1 ratio of epoxy groups to amine hydrogens and 0.2 wt % BYK-310 as a defoamer, and were cured at 100° C. for 100 minutes on glass unless otherwise stated in Table 3. The formulations containing cycloaliphatic epoxy ERL-4221 did not cure well. The RDGE formulations had better results, with low permeation coefficients (2.0-2.5 g·mil/100 in²·day) both alone and in blends with other glycidyl epoxies.

TABLE 3
Permeation of various epoxy/TEPA blends cured at
100° C./100 minutes

| | | | O (epoxy): | Permeation |
|---|---|---|---|---|
| | | TEPA | N—H | (g · mil/ |
| Epoxy Resin | (g) | (g) | (amine) | 100 in² · day) |
| ERL-4221 | 8.24 | 1.76 | 1.00 | not cured |
| 50/50 | | | | |
| RDGE/ERL-4221 | 8.15 | 1.85 | 1.00 | 117.1 |
| RSL-1739 | 8.53 | 1.47 | 1.00 | 4.0 |
| 50/50 | | | | |
| RDGE/RSL-1739 | 8.32 | 1.68 | 1.00 | 3.1 |
| RDGE | 8.05 | 1.95 | 1.00 | 2.1 |
| 85/15 | | | | |
| RDGE/RSL-1739 | 8.14 | 1.86 | 1.00 | 2.0 |
| 80/20 | | | | |
| RDGE/835LV | 3.27 | 0.73 | 1.00 | 2.5 |

### Example 3

### Formulation with Various Amines

This example demonstrates the effect of amine structure on the moisture permeation of the different cured epoxy/amines blends. Several blends were studied using 80/20 RDGE/835LV as the epoxy choice. As shown in Table 4 below, amines with various backbone structures were tested, all with 1 to 1 ratio of epoxy groups to amine hydrogens. All samples cured at 100° C. for 100 minutes. Lower moisture permeability performances were observed in systems containing multifunctional aliphatic amines such as TEPA (tetraethylenepentamine), TETA (triethylene-tetramine), or DETA (diethylenetriamine). As the table indicates, the aromatic amine/epoxy systems either would not melt or did not cure.

TABLE 4
Effect of amine structure variation on moisture permeation in
epoxy/amine systems with 80/20 RDGE/835LV epoxy blend

| | Permeation | |
|---|---|---|
| Amine | g · mil/100 in² · day | Film Properties |
| 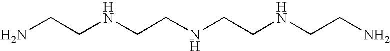 | 2.5 | Transparent, flexible |
| 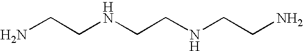 | 2.1 | Transparent, flexible |
| 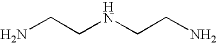 | 1.2 | Transparent, flexible |
| 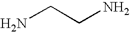 | 3.7 | Transparent, flexible |
| 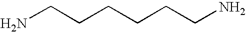 | 8.1 | Some undissolved particles |
| 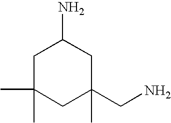 | 4.0 | Transparent, flexible |
| 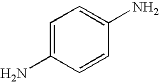 | — | Did not cure |
| 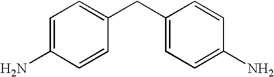 | — | Would not melt |
| 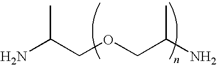 | — | Rubbery, unable to remove from glass plate |

### Example 4

### Curing Under Different Conditions

This example demonstrates the effect of a phenolic catalyst on the curing of epoxy-amine systems. Into a vial containing a clear solution of 1.32 g RDGE and 0.33 g EpicIon EXA-835LV, was added 0.37 g TEPA. The whole mixture was blended using a vortex mixer for one minute. Isothermal curing studies were immediately conducted on a Perkin Elmer DSC at 75° C. and at 100° C. and the results are summarized in Table 5.

TABLE 5
Isothermal Curing of Epoxy/TEPA Blends at Various
Temperatures

| | | | Time to Reach | |
|---|---|---|---|---|
| | | Time to | 90% of Total | |
| | | Peak | Exotherm | |
| Catalyst | Conditions | (min) | (min) | ΔH (J/g) |
| None | Isothermal at | 0.90 | 7.68 | −643 |
| | 75° C. | | | |
| None | Isothermal at | 0.58 | 2.98 | −660 |
| | 100° C. | | | |
| 5% resorcinol | Isothermal at | 0.62 | 5.35 | −600 |
| | 75° C. | | | |

As shown by the table, curing at 75° C. requires significantly longer time than curing at 100° C. when no catalyst is used. This is indicated by the longer time to reach peak exotherm as well as the time needed to complete 90% of the curing. Another sample was prepared by blending 0.082 g resorcinol into a mixture of 1.32 g RDGE and 0.33 g EpicIon EXA-835LV (5 wt % resorcinol based on epoxies) and heating at 100° C. for 10 minutes to make a clear solution. After cooling to room temperature, 0.37 g TEPA was added and the solution was mixed by a vortex mixer. Isothermal curing was again studied for this formulation. The catalyzed formulation had significant improvements in curing performance. Both time to peak temperature and time to reach 90% of total exotherm values shortened compared to the uncatalyzed sample. A film cured at 75° C. for 20 minutes without catalyst was tacky, but when catalyst was added, the film was non-tacky and scratch resistant.

### Example 5

### The Effect of Phenol Loading on Curing Behavior

This example shows the impact of phenolic catalyst loading on the curing behavior. The samples were prepared similarly to Example 4 and analyzed on the Perkin Elmer DSC, heating at 10° C./minute to 150° C. All formulations were prepared with a 1 to 1 ratio of epoxy groups to amine hydrogens. The results are shown in Table 6. The cure started around 65° C. for samples without bisphenol-A or with only 1.5 to 5% bisphenol-A. When the bisphenol-A level was increased to 10%, the cure started at a lower temperature, about 55° C. The curing peak temperature decreased as the loading of the bisphenol-A Increased.

TABLE 6
Curing of Epoxy/TETA Blends at Various Bisphenol-A Loading

| | | Bisphenol-A | | | | |
|---|---|---|---|---|---|---|
| 80/20 | | | % based | Curing | Curing | |
| RDGE/835LV | TETA | | on | Onset | Peak | Delta H |
| (g) | (g) | wt (g) | epoxy | (° C.) | (° C.) | (J/g) |
| 2.78 | 0.56 | 0 | 0 | 65 | 91 | −300 |
| 2.78 | 0.56 | 0.04 | 1.5 | 65 | 90 | −229 |
| 2.78 | 0.56 | 0.148 | 5.3 | 65 | 86 | −225 |
| 2.78 | 0.56 | 0.278 | 10 | 55 | 82 | −253 |

### Example 6

### Comparison of Various Phenols for Catalyzing Epoxy-Amine Cure

This example demonstrates the impact of a phenolic catalyst on the curing behavior and moisture permeation after cure. Several epoxy-TETA samples with various phenolic catalysts were compared. In this case, mixtures of 6.64 g RDGE, 1.67 g EpicIon 8351N, and 1.67 g TETA were prepared and the cure temperatures and exotherm information (Delta H in J/g) were obtained by heating at 10° C./minute to 150° C. on a Perkin Elmer DSC. As shown by the example, resorcinol was able to lower the curing temperature and achieve permeation performance comparable to an uncatalyzed sample cured at 100° C. for 100 minutes. The permeation data was collected at 50° C. and 100% RH. In the case of bisphenol-A, a significant increase in permeation was observed. Another phenol, 2-hydroxy-4-methoxybenzophenone (HMBP) did not help curing at all.

TABLE 7
Comparison of Phenolic Cure Accelerators (wt % based on
epoxy) for Epoxy-TETA Blends

| | | Cure | | | |
|---|---|---|---|---|---|
| Cure | wt % | onset | Peak | Delta H | Permeation |
| accelerator | accelerator | (° C.) | (° C.) | (J/g) | (g * mil/100 in² · day) |
| None | 0 | 62 | 91 | −300 | 2.1 (cured at |
| | | | | | 100° C./100 min) |
| | | | | | tacky (cured at |
| | | | | | 75° C./20 min) |
| bisphenol-A | 5 | 55 | 83 | −225 | 4.5 |
| HMBP | 5 | 75 | 92 | −196 | n/a |
| Resorcinol | 5 | 50 | 78 | −257 | 2.1 |

### Example 7

### Various Substituted Resorcinol Cure Accelerators

Several substituted versions of resorcinol were screened at 5 wt % to determine if the curing temperature could be decreased further. As shown in Table 8 below, all the resorcinol analogues lowered the curing peak, but none were significantly better than resorcinol itself.

TABLE 8
Thermal DSC of Substituted Resorcinol Compounds at 5 wt % in
(80/20 RDGE/835LV)/TEPA

| | wt % | Peak | Area | |
|---|---|---|---|---|
| Cure accelerator | accelerator | (° C.) | (J/g) | Notes |
| None | 0 | 90 | 653 | |
| resorcinol | 5 | 82 | 579 | |
| phloroglucinol | 5 | — | — | not fully |
| | | | | soluble in |
| | | | | epoxy at |
| | | | | 200° C. |
| 5-methoxyresorcinol | 5 | 82 | 582 | |
| orcinol | 5 | 81 | 462 | |
| 4-bromoresorcinol | 5 | 84 | 515 | |
| 4,6-dichlororesorcinol | 5 | 86 | 472 | not fully |
| | | | | dissolved |
| 2,4-dihydroxybenzaldehyde | 5 | 85 | 521 | |
| methyl 3,5-dihydroxy benzoate | 5 | 87 | 522 | |

### Example 8

### Filled Two-Part Formulations

A silica-filled two-part epoxy-amine system was prepared with micron-sized silica and a fumed silica rheology modifier. The ingredients are listed in Table 9.

TABLE 9
Two-part Filled Epoxy-amine System

| | Weight (g) |
|---|---|
| Part A | |
| 80/20 RDGE/835LV | 7.00 |
| Resorcinol | 0.35 |
| Silane adhesion promoter | 0.21 |
| Micron sized silica | 14.00 |
| Fumed silica rheology modifier | 0.15 |
| Part B | |
| TEPA | 1.55 |

The epoxies and resorcinol were heated to 110° C. to dissolve resorcinol. After cooling, silane adhesion promoter was added and the sample was mixed with a vortex mixer. The filler and rheology modifier were then added and the sample was mixed by three-roll mill followed by degassing overnight. TEPA was added to the filled epoxy system and mixed well by wooden stick and vortex mixer.

Adhesion performance was tested by applying two pieces of tape (˜5 mils) approximately a quarter of an inch apart on a TEFLON coated aluminum plate. Using a blade, the formulation was drawn into a film between the tapes. A piece of glass slide and several 4×4 mm glass dies were wiped clean with isopropanol and soaked for 24 h in isopropanol. The slides and dies were removed from the isopropanol and air-dried followed by 5 min UV ozone cleaning. The dies were then placed in the film of formulation and slightly tapped to wet out the entire die. The dies were picked from the formulation coating and placed onto the slides. The dies were slightly tapped to allow the formulation to wet out between the die and the slide. The sealant formulations were cured in an oven for 20 min at 75-80° C. The shear adhesion of the cured samples was tested using a Royce Instrument 552 100K equipped with a 100 kg head and a 300 mil die tool. The dry adhesion was found to be above 40 kg, and remained at this level after one and two weeks of hygrothermal aging at 65° C. and 80% RH.

Moisture permeation coefficient of the above formulation was found to be 1.1 g·mil/100 in²·day. The permeation data was collected at 50° C. and 100% RH.

What is claimed:

1. A curable barrier composition comprising
(a) an aromatic compound having meta-substituted epoxy functionalities: 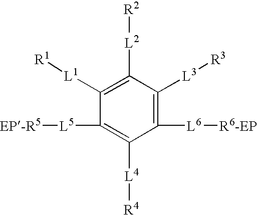
in which
R¹, R², R³, R⁴ are selected from the group consisting hydrogen, halogen, cyano, alkyl, aryl, and substituted alkyl or aryl groups, which may contain an epoxy functionality; R⁵, R⁶ are divalent hydrocarbon linkers having the general structure —CₙH₂ₙ—, wherein n=0-4; in which any two of R¹, R², R³, R⁴, R⁵ and R⁶ may form part of the same cyclic structure;
L¹, L², L³, L⁴, L⁵, L⁶ are a direct bond or a divalent linking group selected from the group consisting of 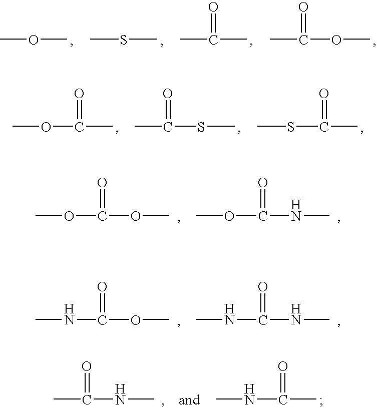
EP and EP′ are curable epoxy functionalities selected from the group consisting of aliphatic epoxy, glycidyl ether, and cycloaliphatic epoxy in which hydrogens on the epoxy may be substituted by one or more alkyl or halogen groups.
(b) a multifunctional aliphatic amine,
(c) optionally, one or more fillers,
(d) optionally, one or more adhesion promoters,
(e) optionally, a phenolic cure accelerator.

2. The curable barrier composition according to claim 1 in which the EP and EP′ functionalities are selected from the group consisting of 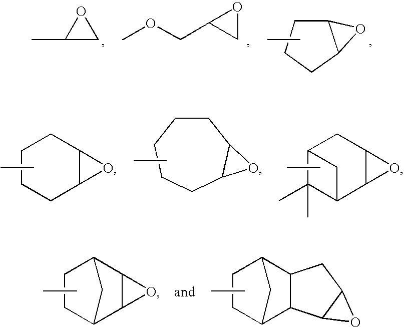
in which the hydrogens on the EP and EP′ structures may be substituted by one or more alkyl or halogen groups.

3. (canceled)

4. The curable barrier composition according to either of claim 1, or 2, in which the multifunctional aliphatic amine is selected from a group consisting of:

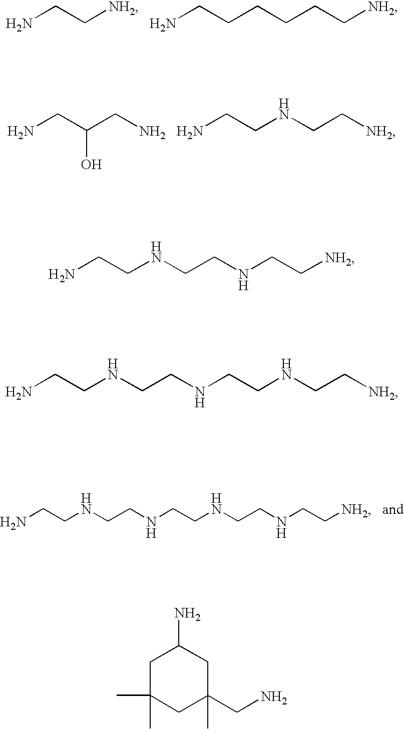

5. The curable barrier composition according to either claim 1 or 2, in which the phenolic cure accelerator is present and is elected from the group consisting of tris-2,4,6-(dimethyl aminomethyl)phenol, resorcinol, 4-ethylresorcinol, 2,5-dimethylresorcinol, phloroglucinol, 2-nitrophloro-glucinol, 5-methoxyresorcinol, orcinol, 2-methylresorcinol, 4-bromoresorcinol, 4-chlororesorcinol, 4,6-dichlororesorcinol, 3,5-dihydroxy-benzaldehyde, 2,4-dihydroxy-benzaldehyde, methyl 3,5-dihydroxy benzoate, methyl 2,4-dihydroxybenzoate, 1,2,4-benzenetriol, pyrogallol, 3,5-dihydroxybenzyl alcohol, 2′,6′-dihydroxyacetophenone, 2′,4′-dihydroxyacetophenone, 3′,5′-dihydroxyacetophenone, 2′,4′-dihydroxy-propiophenone, 2′,4′-dihydroxy-3′-methylacetophenone, 2,4,5-trihydroxy-benzaldehyde, 2,3,4-trihydroxybenzaldehyde, 2,4,6-trihydroxybenzaldehyde, 3,5-dihydroxybenzoic acid, 2,4-dihydroxybenzoic acid, 2,6-dihydroxybenzoic acid, 2-nitroresorcinol, 1,3-dihydroxynaphthalene, hydroquinone, methylhydroquinone, 2,3-dimethylhydroquinone, 2-methoxyhydroquinone, chlorohydroquinone, 2′,5′-dihydroxyacetophenone, 2-isopropyl-1,4-benzenediol, 2,5-dihydroxybenzoic acid, 2,3-dicyanohydroquinone, 1,4-dihydroxynaphthalene, 2′,5′-dihydroxypropiophenone, 1-(2,5-dihydroxy-4-methylphenyl)ethanone, tert-butylhydroquinone, methyl 2,5-dihydroxybenzoate, (2,5-dihydroxyphenyl)acetic acid, 2,4,5-trihydroxybenzoic acid, 4,7-dihydroxy-3-methyl-1-indanone, 2,5-dichlorohydroquinone, tetrafluoro-hydroquinone, ethyl 2,5-dihydroxybenzoate, 2-(2,5-dihydroxybenzylidene)malononitrile, 2-bromo-1,4-benzenediol, ethyl(2,5-dihydroxyphenyl)acetate, 1-(2,4,5-trihydroxyphenyl)-1-butanone, methyl 2,5-dihydroxy-4-methoxybenzoate, 2,6-dinitro-1,4-benzenediol, 2,4,5-trihydroxyphenylalanine, (2,5-dihydroxyphenyl)-(phenyl)methanone, 2,5-ditert-butyl-1,4-benzenediol, 2-(6-methylheptyl)-1,4-benzenediol, 2-(1,1,3,3-tetramethylbutyl)-1,4-benzenediol, dimethyl 2,5-dihydroxyterephthalate, 2,4,5-trichloro-3,6-dihydroxybenzonitrile, 2,5-ditert-pentyl-1,4-benzenediol, 2,5-dibromo-1,4-benzenediol, dimethyl 2,4-diethyl-3,6-dihydroxy-phenylphosphonate, pyrocatechol, 2,3-naphthalenediol, 5-methyl-1,2,3-benzenetriol, 4-methylcatechol, 3-methylcatechol, 3-fluorocatechol, 3-methoxycatechol, 4-chlorocatechol, 4,5-dichlorocatechol, 4-tert-butylcatechol, 3,4,5,6-tetrachloro-1,2-benzenediol, 3-isopropyl-6-methylcatechol, 3-tert-butyl-6-methylcatechol, 3,4-dihydroxybenzonitrile, 3,5-ditert-butylcatechol, 3,5-diisopropylcatechol, 3,4-dihydroxybenzaldehyde, 4-(1,1,3,3-tetramethylbutyl)-1,2-benzenediol, 4-(1,2-dihydroxyethyl)-1,2-benzenediol, 1-(3,4-dihydroxyphenyl)ethanone, 3,4-dihydroxybenzoic acid, 3,4,5-trihydroxybenzamide, 4-nitro-1,2-benzenediol, 4-(2-amino-1-hydroxyethyl)-1,2-benzenediol, 5-methyl-3-(1,1,3,3-tetramethylbutyl)-1,2-benzenediol, (3,4-dihydroxyphenyl)acetic acid, 2-(3,4-dihydroxybenzyl-idene)malononitrile, 3,5-dinitro-1,2-benzenediol, methyl 3,4-dihydroxybenzoate, 2-chloro-1-(3,4-dihydroxyphenyl)ethanone, phenyl(2,3,4-trihydroxyphenyl)methanone, isopropyl 3,4,5-trihydroxybenzoate, 3,4-dihydroxy-2-methylphenylalanine, 3-bromo-4,5-dihydroxybenzoic acid, 2-(3,4-dihydroxy-5-methoxybenzylidene)malononitrile, ethyl 3-(3,4-dihydroxyphenyl)propanoate, 2-phenyl-1-(2,3,4-trihydroxy-phenyl)ethanone, and 3,4,5-trihydroxy-N-(2-hydroxyethyl)benzamide.

6. The curable barrier composition according to claim 1 in which one or more fillers are present and are selected from the group consisting of ground quartz, fused silica, amorphous silica, talc, glass beads, graphite, carbon black, alumina, clays, and nanoclays, mica, vermiculite, aluminum nitride, boron nitride, metal powders, metal flakes, poly(tetrachloroethylene), poly(chlorotrifluoroethylene), poly(vinylidene chloride), CaO, BaO, Na₂SO₄, CaSO₄, MgSO₄, zeolites, silica gel, P₂O₅, CaCl₂, and Al₂O₃.

7. A curable barrier composition according to claim 1 in which the
aromatic compound is selected from the group consisting of epoxidized resoles, bisphenol-F diglycidyl ether, bisphenol-A diglycidyl ether, bisphenol-E diglycidyl ether, epoxidized phenol novolac resins, epoxidized cresol novolac resins, polycyclic epoxy resins, naphthalene diglycidyl ether, and halogenated derivatives of those.

8-14. (canceled)
